(19) United States
(12) Patent Application Publication
(10) Pub. No.: US 2014/0116689 A1
(43) Pub. Date: May 1, 2014

(54) PROCESS FOR MINERAL OIL PRODUCTION USING SURFACTANTS BASED ON ANIONIC ALKYL ALKOXYLATES WHICH HAVE BEEN FORMED FROM GLYCIDYL ETHERS

(71) Applicant: BASF SE, Ludwigshafen (DE)

(72) Inventors: Christian Bittner, Bensheim (DE); Günter Oetter, Frankenthal (DE); Jack Tinsley, Houston, TX (US); Christian Spindler, Houston, TX (US); Gabriela Alvarez-Jürgenson, Mannheim (DE); Sophie Maitro-Vogel, Mannheim (DE)

(73) Assignee: BASF SE, Ludwigshafen (DE)

(21) Appl. No.: 14/060,967

(22) Filed: Oct. 23, 2013

Related U.S. Application Data
(60) Provisional application No. 61/718,739, filed on Oct. 26, 2012.

(51) Int. Cl. C09K 8/584; E21B 43/16

(52) U.S. Cl. CPC C09K 8/584; E21B 43/16
USPC 166/270.1; 507/254; 558/22

(57) ABSTRACT

The present invention relates to a surfactant mixture comprising at least one surfactant of the general formula (I)

R¹O—(CH₂CH(CH₂OR²)O)ₚ-(D)ₙ-(B)ₘ-(A)ₗ-(X)ₖ—Y⁻1/bM^{b+} (I)

where R¹, R², p, D, n, B, m, A, l, X, k, Y⁻, b, M^{b+} are each as defined in the claims and the description. The invention further relates to processes for mineral oil production by means of Winsor type III microemulsion flooding using a surfactant formulation comprising the surfactant mixture.

### CROSS-REFERENCE TO RELATED APPLICATIONS

This application claims benefit (under 35 USC 119(e)) of U.S. Provisional Application Ser. No. 61/718,739, filed Oct. 26, 2012, which is incorporated herein by reference in its entirety.

### BACKGROUND OF THE INVENTION

The present invention relates to processes for mineral oil production by means of Winsor type III microemulsion flooding, in which an aqueous surfactant formulation comprising at least one surfactant of the general formula

R¹O—(CH₂CH(CH₂OR²)O)ₚ-(D)ₙ-(B)ₘ-(A)ₗ-(X)ₖ—Y⁻1/bM^{b+} (I)

is injected through injection wells into a mineral oil deposit and crude oil is withdrawn through production wells from the mineral oil deposit. The invention further relates to a surfactant mixture comprising at least one surfactant of the general formula (I)

In natural mineral oil deposits, mineral oil is present in the cavities of porous reservoir rocks which are sealed toward the surface of the earth by impervious top layers. The cavities may be very fine cavities, capillaries, pores or the like. Fine pore necks may have, for example, a diameter of only about 1 μm. As well as mineral oil, including fractions of natural gas, a deposit comprises water with a greater or lesser salt content.

In mineral oil production, a distinction is generally made between primary, secondary and tertiary production. In primary production, after commencement of drilling of the deposit, the mineral oil flows of its own accord through the borehole to the surface owing to the autogenous pressure of the deposit.

After primary production, secondary production is used. In secondary production, in addition to the boreholes which serve for the production of the mineral oil, called the production wells, further boreholes are drilled into the mineral oil-bearing formation. Water is injected into the deposit through these so-called injection wells in order to maintain the pressure or to increase it again. As a result of the injection of the water, the mineral oil is forced gradually through the cavities into the formation, proceeding from the injection well in the direction of the production well. However, this only works for as long as the cavities are completely filled with oil and the more viscous oil is pushed onward by the water. As soon as the mobile water breaks through cavities, it flows on the path of least resistance from this time, i.e. through the channel formed, and no longer pushes the oil onward.

By means of primary and secondary production, generally only approx. 30 to 35% of the amount of mineral oil present in the deposit can be produced.

It is known that the mineral oil yield can be enhanced further by measures for tertiary oil production. An overview of tertiary oil production can be found, for example, in “Journal of Petroleum Science and Engineering 19 (1998)”, pages 265 to 280. Tertiary oil production includes thermal processes in which hot water or steam is injected into the deposit. This lowers the viscosity of the oil. The flooding media used may likewise be gases such as CO₂ or nitrogen.

Tertiary mineral oil production also includes processes in which suitable chemicals are used as assistants for oil production. These can be used to influence the situation toward the end of water flooding and as a result also to produce mineral oil hitherto held firmly within the rock formation.

Viscous and capillary forces act on the mineral oil which is trapped in the pores of the deposit rock toward the end of the secondary production, the ratio of these two forces relative to one another determining the microscopic oil removal. A dimensionless parameter, called the capillary number N_{c}, is used to describe the action of these forces. It is the ratio of the viscosity forces (velocity×viscosity of the forcing phase) to the capillary forces (interfacial tension between oil and water×wetting of the rock):

$${N}_{c} = \frac{μ v}{σcosθ}$$

In this formula, μ is the viscosity of the mineral oil-mobilizing fluid, ν is the Darcy velocity (flow per unit area), σ is the interfacial tension between mineral oil-mobilizing liquid and mineral oil, and θ is the contact angle between mineral oil and the rock (C. Melrose, C. F. Brandner, J. Canadian Petr. Techn. 58, October-December, 1974). The higher the capillary number N_{c}, the greater the mobilization of the oil and hence also the degree of oil removal.

It is known that the capillary number N_{c} toward the end of secondary mineral oil production is in the region of about 10⁻⁶ and that it is necessary to increase the capillary number to about 10⁻³ to 10⁻² in order to be able to mobilize additional mineral oil.

For this purpose, it is possible to conduct a particular form of the flooding process—what is known as Winsor type III microemulsion flooding. In Winsor type III microemulsion flooding, the injected surfactants are supposed to form a Winsor type III microemulsion with the water phase and oil phase present in the deposit. A Winsor type III microemulsion is not an emulsion with particularly small droplets, but rather a thermodynamically stable, liquid mixture of water, oil and surfactants. The three advantages thereof are that
a very low interfacial tension σ between mineral oil and aqueous phase is thus achieved,
it generally has a very low viscosity and as a result is not trapped in a porous matrix,
it forms with even the smallest energy inputs and can remain stable over an infinitely long period (conventional emulsions, in contrast, require higher shear forces which predominantly do not occur in the reservoir, and are merely kinetically stabilized).

The Winsor type III microemulsion is in an equilibrium with excess water and excess oil. Under these conditions of microemulsion formation, the surfactants cover the oil-water interface and lower the interfacial tension σ more preferably to values of <10⁻² mN/m (ultra-low interfacial tension). In order to achieve an optimal result, the proportion of the microemulsion in the water-microemulsion-oil system, for a defined amount of surfactant, should naturally be at a maximum, since this allows lower interfacial tensions to be achieved.

In this manner, it is possible to alter the form of the oil droplets (interfacial tension between oil and water is lowered to such a degree that the smallest interface state is no longer favored and the spherical form is no longer preferred), and they can be forced through the capillary openings by the flooding water.

When all oil-water interfaces are covered with surfactant, in the presence of an excess amount of surfactant, the Winsor type III microemulsion forms. It thus constitutes a reservoir for surfactants which cause a very low interfacial tension between oil phase and water phase. By virtue of the Winsor type III microemulsion being of low viscosity, it also migrates through the porous deposit rock in the flooding process (emulsions, in contrast, can become trapped in the porous matrix and block deposits). When the Winsor type III microemulsion meets an oil-water interface as yet uncovered with surfactant, the surfactant from the microemulsion can significantly lower the interfacial tension of this new interface, and lead to mobilization of the oil (for example by deformation of the oil droplets).

The oil droplets can subsequently combine to give a continuous oil bank. This has two advantages:

Firstly, as the continuous oil bank advances through new porous rock, the oil droplets present there can coalesce with the bank.

Moreover, the combination of the oil droplets to give an oil bank significantly reduces the oil-water interface and hence surfactant no longer required is released again. Thereafter, the surfactant released, as described above, can mobilize oil droplets remaining in the formation.

Winsor type III microemulsion flooding is consequently an exceptionally efficient process, and requires much less surfactant compared to an emulsion flooding process. In microemulsion flooding, the surfactants are typically optionally injected together with cosolvents and/or basic salts (optionally in the presence of chelating agents). Subsequently, a solution of thickening polymer is injected for mobility control. A further variant is the injection of a mixture of thickening polymer and surfactants, cosolvents and/or basic salts (optionally with chelating agent), followed by a solution of thickening polymer for mobility control. These solutions should generally be clear in order to prevent blockages of the reservoir.

The requirements on surfactants for tertiary mineral oil production differ significantly from requirements on surfactants for other applications: suitable surfactants for tertiary oil production should reduce the interfacial tension between water and oil (typically approx. 20 mN/m) to particularly low values of less than 10⁻² mN/m in order to enable sufficient mobilization of the mineral oil. This has to be done at the customary deposit temperatures of approx. 15° C. to 130° C. and in the presence of water with a high salt content, more particularly also in the presence of high proportions of calcium and/or magnesium ions; the surfactants thus also have to be soluble in deposit water with a high salt content.

To fulfill these requirements, there have already been frequent proposals of mixtures of surfactants, especially mixtures of anionic and nonionic surfactants.

U.S. Pat. No. 4,446,079 A describes anionic surfactants of the alkyl ether sulfate or alkyl ether sulfonate type, the hydrophobic moiety of the surfactants being obtained by joining two alcohols by means of epichlorohydrin: R¹O—CH₂CH(CH₂—OR²)O—(CH₂CH₂O)ₙ—R³SO₃M. R¹ and R² are each a hydrocarbyl radical having 1-15 carbon atoms.

EP 0523111 B1 describes anionic surfactants of the alkyl ether sulfate or alkyl ether sulfonate type, the hydrophobic moiety of the surfactants being obtainable by joining two alcohols by means of epichlorohydrin or reaction of an alcohol with a long-chain epoxide: R³O—CH₂CH(CH₂—OR⁴)O-(A)ₚ-(Y)ᵣSO₃H or R³O—CH₂CH(CH₂R⁴)O-(A)ₚ-(Y)ᵣSO₃H or R⁴O—CH₂CH(CH₂R³)O-(A)ₚ-(Y)ᵣSO₃H and the salts thereof. R³ is a hydrocarbyl radical having 8 carbon atoms and R⁴ is a hydrocarbyl radical having 4-6 carbon atoms. A is ethyleneoxy or propyleneoxy, and p has values of 0 to 1.9.

EP 0523112 B1 describes anionic surfactants of the alkyl ether sulfate or alkyl ether sulfonate type, the hydrophobic moiety of the surfactants being obtainable by joining two alcohols by means of epichlorohydrin or reaction of an alcohol with a long-chain epoxide: R³O—CH₂CH(CH₂—OR⁴)O-(A)ₚ-(Y)ᵣSO₃H or R³O—CH₂CH(CH₂R⁴)O-(A)ₚ-(Y)ᵣSO₃H or R⁴O—CH₂CH(CH₂R³)O-(A)ₚ-(Y)ᵣSO₃H and the salts thereof. R³ is a hydrocarbyl radical having 8-12 carbon atoms and R⁴ is a hydrocarbyl radical having 2-6 carbon atoms. A is ethyleneoxy or propyleneoxy.

The use parameters, for example type, concentration and mixing ratio of the surfactants used relative to one another, are adjusted by the person skilled in the art to the conditions prevailing in a given oil formation (for example temperature and salt content).

As described above, mineral oil production is proportional to the capillary number. The lower the interfacial tension between oil and water, the higher the capillary number. The higher the mean number of carbon atoms in the crude oil, the more difficult low interfacial tensions are to achieve. For low interfacial tensions, suitable surfactants are those which possess a long alkyl radical. The longer the alkyl radical, the better the reducibility of the interfacial tensions. However, the availability of such compounds is very limited.

It is therefore an object of the invention to provide a particularly efficient surfactant or an efficient surfactant mixture for use for surfactant flooding, and an improved process for tertiary mineral oil production.

### BRIEF SUMMARY OF THE INVENTION

The object is achieved by a surfactant mixture comprising at least one surfactant of the general formula (I)

R¹O—(CH₂CH(CH₂OR²)O)ₚ-(D)ₙ-(B)ₘ-(A)ₗ-(X)ₖ—Y⁻1/bM^{b+} (I)

where
R¹ is a linear or branched, saturated or unsaturated aliphatic hydrocarbyl radical having 16 to 36 carbon atoms or an aliphatic-aromatic hydrocarbyl radical having 16 to 36 carbon atoms,
R² is a linear or branched, saturated or unsaturated aliphatic hydrocarbyl radical having 8 to 22 carbon atoms,
D is butyleneoxy,
B is propyleneoxy,
A is ethyleneoxy,
X is an alkylene, hydroxyalkylene or alkenylene group having 1 to 10 carbon atoms,
M^{b+} is a cation,
p is a number from 1 to 10,
n is a number from 0 to 99,
m is a number from 1 to 99,
l is a number from 1 to 99,
b is 1 or 2,
Y⁻ is SO₃⁻ and k is 0, or Y⁻ is a sulfonate (SO₃⁻), sulfate (OSO₃⁻) or carboxylate (CO₂⁻) group and k is 1,
the alkyleneoxy groups (CH₂CH(CH₂OR²)O), A, B and D are distributed randomly, distributed alternately or are in the form of two, three, four, five or more blocks each of identical alkyleneoxy groups in any sequence,
and the sum of l+m+n+p is in the range from 3 to 99.

A further aspect of the present invention is a process for tertiary mineral oil production by means of Winsor type Ill microemulsion flooding, in which an aqueous surfactant formulation comprising at least the inventive surfactant of the general formula R¹O—(CH₂CH(CH₂OR²)O)ₚ-(D)ₙ-(B)ₘ-(A)ₗ-(X)ₖ—Y⁻1/b M^{b+} (I) is injected through at least one injection well into a mineral oil deposit, the interfacial tension between oil and water is lowered to values of <0.1 mN/m, preferably to values of <0.05 mN/m, more preferably to values of <0.01 mN/m, and crude oil is withdrawn through at least one production well from the deposit.

In a preferred embodiment,
m is a number from 4 to 15,
p is a number from 1 to 5, and
the (CH₂CH(CH₂OR²)O), A, B and D groups are present to an extent of more than 60% in block form and in the sequence (CH₂CH(CH₂OR²)O), D, B, A beginning from R¹O, and the sum of l+m+n+p is in the range from 5 to 70.

In a particularly preferred embodiment,
n is a number from 2 to 15,
p is a number from 1 to 5, and
the (CH₂CH(CH₂OR²)O), A, B and D groups are present to an extent of more than 60% in block form and in the sequence (CH₂CH(CH₂OR²)O), D, B, A beginning from R¹O,
and the sum of l+m+n+p is in the range from 5 to 70.

In a further preferred embodiment,
R¹ is a linear or branched, saturated or unsaturated aliphatic hydrocarbyl radical having 16 to 22 carbon atoms or an aliphatic-aromatic hydrocarbyl radical having 16 to 22 carbon atoms,
R² is a linear or branched, saturated or unsaturated aliphatic hydrocarbyl radical having 8 to 22 carbon atoms, and
Y^{a-} is selected from the group of carboxylate groups and sulfate groups,
k is 1.

In a further preferred embodiment of the invention, a surfactant formulation comprising, as well as a surfactant of the general formula (I), an organic sulfonate having 14 to 28 carbon atoms as a further surfactant is provided.

### DETAILED DESCRIPTION OF THE INVENTION

Specific details of the invention are as follows:

In the process according to the invention for mineral oil production by means of Winsor type III microemulsion flooding as described above, an aqueous surfactant formulation comprising at least one surfactant of the general formula R¹O—(CH₂CH(CH₂OR²)O)ₚ-(D)ₙ-(B)ₘ-(A)ₗ-(X)ₖ Y^{a-} a/b M^{b+} (I) is used. It may additionally comprise still further surfactants and/or other components.

In the context of the process according to the invention for tertiary mineral oil production by means of Winsor type III microemulsion flooding, the use of the inventive surfactant mixture lowers the interfacial tension between oil and water to values of <0.1 mN/m, preferably to <0.05 mN/m, more preferably to <0.01 mN/m. Thus, the interfacial tension between oil and water is lowered to values in the range from 0.1 mN/m to 0.0001 mN/m, preferably to values in the range from 0.05 mN/m to 0.0001 mN/m, more preferably to values in the range from 0.01 mN/m to 0.0001 mN/m.

The R¹ radical is a linear or branched, saturated or unsaturated aliphatic hydrocarbyl radical having 16 to 36 carbon atoms or an aliphatic-aromatic hydrocarbyl radical having 16 to 36 carbon atoms, and R² is a linear or branched, saturated or unsaturated aliphatic hydrocarbyl radical having 8 to 22 carbon atoms.

In the case of aliphatic-aromatic hydrocarbyl radicals having 16 to 36 carbon atoms for R¹, the radicals may, for example, be dodecylphenyl, tetradecylphenyl, 3-pentadecylphenyl, unsaturated 2-pentadecylphenyl, hexadecylphenyl, octadecylphenyl, distyrylphenyl or tristyrylphenyl.

In the case of branched R¹ or R² radicals, the degree of branching in R¹ or R² is in the range of 0.1-5 and preferably of 0.1-3.5.

In this context, the term “degree of branching” is defined in a manner known in principle as the number of methyl groups in one molecule of the alcohol minus 1. The mean degree of branching is the statistical mean of the degrees of branching of all molecules in a sample.

It is a preferred embodiment, however, if R¹ is a linear or branched, saturated or unsaturated aliphatic hydrocarbyl radical having 16 to 36 carbon atoms and R² is a linear or branched, saturated or unsaturated aliphatic hydrocarbyl radical having 8 to 22 carbon atoms.

The alcohol R¹OH from which the surfactant of the general formula (I) is formed is preferably a primary alcohol. R¹OH may, for example, be C16C18 fatty alcohol, oleyl alcohol, linoleyl alcohol, linolenyl alcohol, eicosanol, behenyl alcohol, erucyl alcohol, Guerbet alcohols, Heptadecanol N from BASF or Neodol 67 from Shell.

R² may, for example, be 2-ethylhexyl, isononyl, 2-propylheptyl, isodecyl, n-dodecyl, isotridecyl, n-tetradecyl, hexadecyl, isohexadecyl, isoheptadecyl, oleyl, linoleyl, linolenyl, behenyl or erucyl.

In the above formula, A is ethyleneoxy, B is propyleneoxy and D is butyleneoxy. In a preferred embodiment, butyleneoxy is 80% 1,2-butyleneoxy or more.

In the general formula defined above, l, m, n and p are each integers. It is clear to the person skilled in the art in the field of polyalkoxylates, however, that this definition is the definition of a single surfactant in each case. In the case of presence of surfactant mixtures or surfactant formulations comprising a plurality of surfactants of the general formula, the numbers l, m, n and p are each mean values over all molecules of the surfactants, since the alkoxylation of alcohol with ethylene oxide or propylene oxide in each case affords a certain distribution of chain lengths. This distribution can be described in a manner known in principle by what is called the polydispersity D. D=M_{w}/Mₙ is the ratio of the weight-average molar mass and the number-average molar mass. The polydispersity can be determined by methods known to those skilled in the art, for example by means of gel permeation chromatography.

In the above general formula, l is a number from 1 to 99, preferably 1 to 50, more preferably 1 to 35.

In the above general formula, m is a number from 1 to 99, preferably 4 to 30, more preferably 5 to 20.

In the above general formula, n is a number from 0 to 99, preferably 1 to 20, more preferably 2 to 10.

In the above general formula, p is a number from 1 to 10, preferably 1 to 5, and more preferably 1 to 3.

According to the invention, the sum of l+m+n+p is a number in the range from 3 to 99, preferably in the range from 5 to 70, more preferably in the range from 15 to 65.

The ethyleneoxy (A), propyleneoxy (B), butyleneoxy (D) and (CH₂CH(CH₂OR²)O) blocks are distributed randomly, distributed alternately or are in the form of two, three, four, five or more blocks in any sequence.

In a preferred embodiment of the invention, in the presence of a plurality of different alkyleneoxy blocks, preference is given to the sequence R¹O, (CH₂CH(CH₂OR²)O) block, butyleneoxy block, propyleneoxy block, ethyleneoxy block.

In a particularly preferred embodiment of the invention, the (CH₂CH(CH₂OR²)O), A, B and D groups are present to an extent of more than 60% in block form and in the sequence (CH₂CH(CH₂OR²)O), D, B, A beginning from R¹O,

In the above general formula, X is an alkylene group, hydroxylalkylene group or alkenylene group having 1 to 10 and preferably 1 to 3 carbon atoms. The alkylene group is preferably a methylene, ethylene or propylene group.

The variable k is either 0 or 1.

In the above general formula, Y is a sulfonate, sulfate or carboxylate group in the case that k=1. In the case that k=0, Y is SO₃⁻, the end effect of which is to result in a surfactant having a sulfate group as the functional end group.

For example, for X—Y⁻, the result is a sulfate group (SO₃⁻), an ethylenesulfonate group (CH₂CH₂SO₃⁻), a propylenesulfonate group (CH₂CH₂CH₂SO₃⁻), a 2-hydroxypropylenesulfonate group (CH₂CH(OH)CH₂SO₃⁻), a methylenecarboxylate group (CH₂CO₂⁻) or an ethylenecarboxylate group (CH₂CH₂CO₂⁻).

In the above formula, M^{b+} is a cation, preferably a cation selected from the group of Na⁺, K⁺, Li⁺, NH₄⁺, H⁺, Mg²⁺ and Ca²⁺ (preferably Na⁺, K⁺ or NH₄⁺). Overall, b may have values of 1, 2 or 3.

The alcohols R¹—OH which serve as a starting compound for preparation of the inventive surfactants can be prepared by
hydrolysis of fats and oils with water or methanol to give the corresponding acids and methyl esters and subsequent hydrogenation to give the primary alcohol,
oligomerization of ethylene over aluminum catalysts and subsequent hydrolysis,
oligomerization of ethylene, propylene and/or butylene to give corresponding olefins and subsequent reaction with CO and H₂,
the alkylation of phenol with corresponding olefins,
the linkage of two aldehydes via aldol reaction or aldol condensation and subsequent hydrogenation, or
the dimerization of alcohols of that type with elimination of water.

The glycidyl ethers CH₂(O)CHCH₂OR² can be prepared by
reaction of epichlorohydrin with the alcohol R²OH to give the corresponding chlorohydrin, subsequent reaction with alkali (e.g. NaOH) and optional final distillation,
reaction of epichlorohydrin with the alcohol R²OH in the presence of alkali (e.g. NaOH) and a phase transfer catalyst and optional final distillation, or
reaction of alcohol R²OH with allyl chloride, followed by epoxidation with peroxides and/or peracids and optional final distillation.

Accordingly is a process for preparing surfactants of the general formula R¹O—(CH₂CH(CH₂OR²)O)ₚ-(D)ₙ-(B)ₘ-(A)ₗ-(X)ₖY⁻1/b M^{b+} (I) in which R¹, R², D, B, A, X, Y⁻, M^{b+}, b, n, m, l and p are each as defined above, comprising the steps of:
(a) preparing alcohols R¹OH,
(b) preparing glycidyl ethers CH₂(O)CHCH₂OR²,
(c) alkoxylating the alcohols obtained in process step (a) with the glycidyl ether obtained in process step (b) and with alkylene oxides,
(d) optionally introducing the spacer group X, and
(e) adding the Y group onto the compounds obtained in process step (c) or (d), or sulfonating the compounds obtained in process step (c).

The preparation of the alcohols R¹OH in process step (a) is known in principle to those skilled in the art.

The preparation of the glycidyl ethers in process step (b) is known in principle to those skilled in the art. Preference is given to the reaction of alcohol R²OH with 1-1.5 eq of epichlorohydrin in the presence of 25-50% sodium hydroxide solution and of a phase transfer catalyst at 40-60° C. The phase transfer catalysts used may be tertiary amines or quaternized amines, for example tetrabutylammonium chloride. This is followed by a phase separation and optionally purification by distillation.

The surfactants according to the general formula can be prepared in a manner known in principle by alkoxylating corresponding alcohols R¹OH in process step (c). The performance of such alkoxylations is known in principle to those skilled in the art. It is likewise known to those skilled in the art that the reaction conditions, especially the selection of the catalyst, can influence the molecular weight distribution of the alkoxylates.

The surfactants according to the general formula can preferably be prepared in process step (c) by base-catalyzed alkoxylation. In this case, the alcohol R¹—OH can be admixed in a pressure reactor with alkali metal hydroxides, preferably potassium hydroxide, or with alkali metal alkoxides, for example sodium methoxide. Water still present in the mixture can be drawn off by means of reduced pressure (for example <100 mbar) and/or increasing the temperature (30 to 150° C.). Thereafter, the alcohol is present in the form of the corresponding alkoxide. This is followed by inertization with inert gas (for example nitrogen) and stepwise addition of the alkylene oxide(s) at temperatures of 60 to 180° C. up to a maximum pressure of 10 bar. In a preferred embodiment, the alkylene oxide is metered in initially at 130° C. In the course of the reaction, the heat of reaction released causes the temperature to rise up to 180° C. In a further preferred embodiment of the invention, the glycidyl ether is first added at a temperature in the range from 135 to 155° C., then the butylene oxide is added at a temperature in the range from 135 to 155° C., then the propylene oxide is added at a temperature in the range from 130 to 145° C., and subsequently the ethylene oxide is added at a temperature in the range from 125 to 145° C. At the end of the reaction, the catalyst can, for example, be neutralized by adding acid (for example acetic acid or phosphoric acid) and be filtered off if required.

However, the alkoxylation of the alcohols R¹OH can also be undertaken by means of other methods, for example by acid-catalyzed alkoxylation. In addition, it is possible to use, for example, double hydroxide clays, as described in DE 4325237 A1, or it is possible to use double metal cyanide catalysts (DMC catalysts). Suitable DMC catalysts are disclosed, for example in DE 10243361 A1, especially in paragraphs [0029] to [0041] and the literature cited therein. For example, it is possible to use catalysts of the Zn—Co type. To perform the reaction, the alcohol R¹OH can be admixed with the catalyst, and the mixture dewatered as described above and reacted with the alkylene oxides as described. Typically not more than 1000 ppm of catalyst based on the mixture are used, and the catalyst can remain in the product owing to this small amount. The amount of catalyst may generally be less than 1000 ppm, for example 250 ppm or less.

Process step (d) relates to the introduction of the spacer group X, provided that it is not a single bond. This is followed, as process step (e), by the introduction of the anionic group. Steps (d) and (e) are preferably effected simultaneously, and so they can be combined in one step.

The anionic group is finally introduced in process step (e). This is known in principle to those skilled in the art. In principle, the anionic group XY⁻ is composed of the functional group Y⁻, which is a sulfate, sulfonate or carboxylate group, and optionally the spacer X. In the case of a sulfate group, it is possible, for example, to employ the reaction with sulfuric acid, chlorosulfonic acid or sulfur trioxide in a falling-film reactor with subsequent neutralization. In the case of a sulfonate group, it is possible, for example, to employ the reaction with propane sultone and subsequent neutralization, with butane sultone and subsequent neutralization, with vinylsulfonic acid sodium salt or with 3-chloro-2-hydroxypropanesulfonic acid sodium salt. To prepare sulfonates, the terminal OH group can also be converted to a chloride, for example with phosgene or thionyl chloride, and then reacted, for example, with sulfite. In the case of a carboxylate group, it is possible, for example, to employ the oxidation of the alcohol with oxygen and subsequent neutralization, or the reaction with chloroacetic acid sodium salt. Carboxylates can also be obtained, for example, by Michael addition of (meth)acrylic acid or ester.

### Further Surfactants

In addition to the surfactants of the general formula (I), the formulation may additionally optionally comprise further surfactants. Preference is given to organic sulfonates having 14 to 28 carbon atoms. They are, for example, anionic surfactants of the alkylarylsulfonate or olefinsulfonate type (alpha-olefinsulfonate or internal olefinsulfonate). These may, for example, be dodecylbenzenesulfonate, tetradecylbenzenesulfonate, C14-alpha-olefinsulfonate, C16-alpha-olefinsulfonate, C15C18-internal olefinsulfonate, C20C24-internal olefinsulfonate or C24C28-internal olefinsulfonate. Other possibilities are, for example, anionic surfactants of the petroleumsulfonate or paraffinsulfonate type. In addition, it is also possible to use nonionic surfactants of the alkyl ethoxylate or alkyl polyglucoside type. It is also possible to use betaine surfactants. These further surfactants may especially also be oligomeric or polymeric surfactants. It is advantageous to use such polymeric cosurfactants to reduce the amount of surfactants needed to form a microemulsion. Such polymeric cosurfactants are therefore also referred to as “microemulsion boosters”. Examples of such polymeric surfactants comprise amphiphilic block copolymers which comprise at least one hydrophilic block and at least one hydrophobic block. Examples comprise polypropylene oxide-polyethylene oxide block copolymers, polyisobutene-polyethylene oxide block copolymers, and comb polymers with polyethylene oxide side chains and a hydrophobic main chain, where the main chain preferably comprises essentially olefins or (meth)acrylates as monomers. The term “polyethylene oxide” here shall in each case include polyethylene oxide blocks comprising propylene oxide units as defined above. Further details of such surfactants are disclosed in WO 2006/131541 A1.

### Processes for Mineral Oil Production

In the process according to the invention for mineral oil production, a suitable aqueous formulation of the surfactants of the general formula is injected through at least one injection well into the mineral oil deposit and crude oil is withdrawn through at least one production well from the deposit. The term “crude oil” in this context of course does not mean single-phase oil, but rather the usual crude oil-water emulsions. In general, a deposit is provided with several injection wells and with several production wells.

The main effect of the surfactant lies in the reduction of the interfacial tension between water and oil—desirably to values distinctly <0.1 mN/m. After the injection of the surfactant formulation, called the “surfactant flooding” or preferably the Winsor type III “microemulsion flooding”, the pressure can be maintained by injecting water into the formation (“water flooding”), or preferably a higher-viscosity aqueous solution of a polymer with high thickening action (“polymer flooding”). There are also known techniques in which the surfactants are first of all allowed to act on the formation. A further known technique is the injection of a solution of surfactants and thickening polymers, followed by a solution of thickening polymer. The person skilled in the art is aware of details of the industrial performance of “surfactant flooding”, “water flooding”, and “polymer flooding”, and employs an appropriate technique according to the type of deposit.

For the process according to the invention, an aqueous formulation comprising surfactants of the general formula is used. In addition to water, the formulations may optionally also comprise water-miscible or at least water-dispersible organic substances or other substances. Such additives serve especially to stabilize the surfactant solution during storage or transport to the oil field. The amount of such additional solvents should, however, generally not exceed 50% by weight, preferably 20% by weight. In a particularly advantageous embodiment of the invention, exclusively water is used for formulation. Examples of water-miscible solvents include especially alcohols such as methanol, ethanol and propanol, butanol, sec-butanol, pentanol, butyl ethylene glycol, butyl diethylene glycol or butyl triethylene glycol.

In a preferred embodiment of the invention, the surfactants of the general formula R¹O—(CH₂CH(CH₂OR²)O)ₚ-(D)ₙ-(B)ₘ-(A)ₗ-(X)ₖ 1/b M^{b+} (I), in the formulation which ultimately into the injection into the deposit, are to constitute the main component of all the surfactants. These are preferably at least 25% by weight, more preferably at least 30% by weight, even more preferably at least 40% by weight and even more preferably still at least 50% by weight of all surfactants used.

The mixture used in accordance with the invention can preferably be used for surfactant flooding of deposits. It is especially suitable for Winsor type III microemulsion flooding (flooding in the Winsor III range or in the range of existence of the bicontinuous microemulsion phase). The technique of microemulsion flooding has already been described in detail at the outset.

In addition to the surfactants, the formulations may also comprise further components, for example C₄ to C₈ alcohols and/or basic salts (called “alkali surfactant flooding”). Such additives can be used, for example, to reduce retention in the formation. Examples of useful basic salts include NaOH and Na₂CO₃. Optionally, the basic salts are used together with complexing agents such as EDTA or with polycarboxylates. The ratio of the alcohols based on the total amount of surfactant used is generally at least 1:1—however, it is also possible to use a significant excess of alcohol. The amount of basic salts may typically range from 0.1% by weight to 5% by weight.

The deposits in which the process is employed generally have a temperature of at least 10° C., for example 10 to 150° C., preferably a temperature of at least 15° C. to 120° C. The total concentration of all surfactants together is 0.05 to 5% by weight, based on the total amount of the aqueous surfactant formulation, preferably 0.1 to 2.5% by weight. The person skilled in the art makes a suitable selection according to the desired properties, especially according to the conditions in the mineral oil formation. It is clear here to the person skilled in the art that the concentration of the surfactants can change after injection into the formation because the formulation can mix with formation water, or surfactants can also be absorbed on solid surfaces of the formation. It is the great advantage of the mixture used in accordance with the invention that the surfactants lead to a particularly good lowering of interfacial tension.

It is of course possible and also advisable first to prepare a concentrate which is only diluted on site to the desired concentration for injection into the formation. In general, the total concentration of the surfactants in such a concentrate is 10 to 70% by weight.

The examples which follow are intended to illustrate the invention:

### Part I: Synthesis of the Surfactants

### General Method 1: Synthesis of the Glycidyl Ether

A 2 l flask is initially charged with the alcohol (1 eq.), which is melted if necessary at 50° C. Sodium hydroxide solution (50% in water, 4.75 eq) and dimethylcyclohexylamine (1250 ppm) are added and the mixture is heated to 50° C. while stirring. Epichlorohydrin (1.5 eq) is added at 50° C. while stirring within one hour. The reaction mixture is stirred at 50° C. for a further 5 h. Subsequently, water is added and the organic phase is removed. The crude product is purified by distillation.

### General Method 2: Alkoxylation by Means of KOH Catalysis

In a 2 l autoclave, the alcohol to be alkoxylated (1.0 eq) is optionally admixed with an aqueous KOH solution comprising 50% by weight of KOH. The amount of KOH is 0.2% by weight of the product to be prepared. The mixture is dewatered while stirring at 100° C. and 20 mbar for 2 h. This is followed by purging three times with N₂, establishment of a supply pressure of approx. 1.3 bar of N₂ and an increase in the temperature to 120 to 130° C. The glycidyl ether is metered in such that the temperature remains between 135° C. and 160° C. The alkylene oxide is metered in such that the temperature remains between 135° C. and 145° C. (in the case of ethylene oxide) or 135 and 145° C. (in the case of propylene oxide) or 135 and 145° C. (in the case of 1,2-butylene oxide). This is followed by stirring at 125 to 145° C. for a further 5 h, purging with N₂, cooling to 70° C. and emptying of the reactor. The basic crude product is neutralized with the aid of acetic acid. Alternatively, neutralization can also be effected with commercial magnesium silicates, which are subsequently filtered off. The light-colored product is characterized with the aid of a 1H NMR spectrum in CDCl3, gel permeation chromatography and an OH number determination, and the yield is determined.

### General Method 3: Sulfonation by Means of Chlorosulfonic Acid

In a 1 l round-bottom flask, the alkyl alkoxylate to be sulfonated (1.0 eq) is dissolved in 1.5 times the amount of dichloromethane (based on percent by weight) and cooled to 5 to 10° C. Thereafter, chlorosulfonic acid (1.1 eq) is added dropwise at such a rate that the temperature does not exceed 10° C. The mixture is allowed to warm up to room temperature and is left to stir at this temperature under N₂ flow for 4 h, before the above reaction mixture is added dropwise to an aqueous NaOH solution of half the volume at max. 15° C. The amount of NaOH is calculated so as to give a slight excess based on the chlorosulfonic acid used. The resulting pH is approx. pH 9 to 10. The dichloromethane is removed on a rotary evaporator at max. 50° C. under a gentle vacuum.

The product is characterized by 1H NMR and the water content of the solution is determined (approx. 70%).

For the synthesis, the alcohols below were used.

| Alcohol | |
|---|---|
| R¹OH | Description |
| C₁₆C₁₈—OH | commercially available fatty alcohol mixture consisting of |
| | linear C₁₆H₃₃—OH and C₁₈H₃₇—OH |
| C₃₂—OH | commercially available Guerbet alcohol C₃₂H₆₅—OH, |
| | purity >98% |

For the synthesis, the glycidyl ether below was used.

| R² | Description |
|---|---|
| 2-ethylhexyl | commercially available 2-ethylhexyl glycidyl ether from |
| | Aldrich |

### Performance Tests

The surfactants obtained were used to conduct the following tests, in order to assess the suitability thereof for tertiary mineral oil production.

### Description of the Test Methods

### Interfacial Tension

Interfacial tensions were measured directly by the spinning drop method on dead crude oils (API approx. 14) and saline injection waters at the respective deposit temperatures. For this purpose, a surfactant solution described in detail in the test results combined with a cosolvent (butyl diethylene glycol) and a water hardness-binding agent (chelate) is used. An oil droplet was added to this at deposit temperature and the interfacial tension was read off after 1-2 h.

### Test Results

TABLE 1
Interfacial tensions in dead crude oil (approx. 14° API) at 20° C.

| | alkyl - AO - anionic group: | BDG^{a)} | Na₂CO₃ | Chelate^{b)} | Salinity | | IFT |
|---|---|---|---|---|---|---|---|
| Ex. | cosurfactant [total 1000 ppm] | [ppm] | [ppm] | [ppm] | [ppm] | T [° C.] | [mN/m] |
| C1 | C₁₆C₁₈- 7 PO - SO₄Na^{c)} | 2000 | 2500 | 700 | 16 100 | 20 | 0.0173 |
| C2 | C₁₆C₁₈- 7 BuO - 7 PO - 10 | 1000 | 2500 | 700 | 16 100 | 20 | 0.0100 |
| | EO - SO₄Na^{d)}:Hostapur | | | | | | |
| | SAS 30^{e)} = 7:3 | | | | | | |
| C3 | C₃₂ - 7 BuO - 7 PO - 10 EO - | 1000 | 2000 | 700 | 16 100 | 20 | 0.0063 |
| | SO₄Na^{f)}:Lutensol XP 140^{g)} = | | | | | | |
| | 8:2 | | | | | | |
| C4 | C₃₂ - 7 BuO -7 PO - 10 EO - | 2000 | 2500 | 700 | 20 000 | 20 | 0.0043 |
| | SO₄Na^{f)}:Hostapur SAS 30^{e)} = | | | | | | |
| | 8:2 | | | | | | |
| 5 | C₁₆C₁₈- 1 2-EH-glycidyl ether - | 2000 | 2500 | 700 | 20 000 | 20 | 0.0023 |
| | 7 BuO - 7 PO - 25 EO - | | | | | | |
| | SO₄Na^{h)}:Hostapur SAS 30^{e)} = | | | | | | |
| | 8:2 | | | | | | |

^{a)}butyl diethylene glycol
^{b)}polyacrylic acid sodium salt
^{c)}surfactant prepared by alkoxylation of C16C18 fatty alcohol with 7 eq of propylene oxide and by subsequent sulfonation
^{d)}surfactant prepared by alkoxylation of C16C18 fatty alcohol with 7 eq of butylene oxide, 7 eq of propylene oxide and 10 eq of ethylene oxide and by subsequent sulfonation
^{e)}paraffinsulfonate from Clariant
^{f)}surfactant prepared by alkoxylation of C32 Guerbet alcohol with 7 eq of butylene oxide, 7 eq of propylene oxide and 10 eq of ethylene oxide and by subsequent sulfonation
^{g)}surfactant from BASF, prepared by alkoxylation of C10 Guerbet alcohol with 14 eq of ethylene oxide
^{h)}surfactant of the formula (I) where R¹ = n-C₁₆H₃₃, n-C₁₈H₃₇, R² = 2-ethylhexyl, p = 1, n = 7, m = 7, l = 10, k = 0, Y⁻ = SO₃⁻, M⁺ = Na⁺

As can be seen in table 1 in comparative example 01, a standard system based on C16C18-7 PO-sulfate gives an interfacial tension of 0.0173 mN/m in the dead crude oil. The advantage of this system is the good availability of the surfactant, since the parent C16C18 fatty alcohol is available in large volume (approx. 200.000 to/y). It is known from the specialist literature (e.g. T. Sottmann, R. Strey “Microemulsions”, Fundamentals of Interface and Colloid Science 2005, Volume V, chapter 5) that the interfacial tension rises with chain length of the oil used. In order to obtain low interfacial tensions in heavy oils, a surfactant with a comparatively long hydrophobic moiety is therefore needed.

By extending the hydrophobic moiety of the surfactant by incorporation of BuO, it is possible—as can be seen in comparative example C2—to lower the interfacial tension further, but it was not possible to attain a value below 0.01 mN/m.

This is achieved by using a surfactant based on a very long-chain alcohol, for example a distillatively purified Guerbet alcohol having 32 carbon atoms: in comparative example C3, a value of 0.0063 mN/m was achieved.

The formation of such surfactants requires alcohols which should have 30 or more carbon atoms. Linear or lightly branched alcohols within this carbon chain range (for example Ziegler alcohols through ethylene oligomerization and subsequent introduction of the alcohol group) are available only in extremely small amounts and are not an option for tertiary mineral oil production.

The only known alcohols on the market to date are long-chain Guerbet alcohols. These are prepared by dimerization of alcohols with elimination of water and are primary alcohols having a branch in the 2 position. However, the longer the alcohol used, the more difficult this dimerization is, i.e. the conversions are incomplete (in the case of Guerbet alcohols having more than 28 carbon atoms, they are usually only 70%).

If Guerbet alcohols having more than 30 carbon atoms and purities>70% are desired, distillation is required to remove the low molecular weight alcohol. This complicates and increases the expense of production.

It has been found that, surprisingly, surfactants formed from readily available shorter-chain fatty alcohols are actually even better, provided that they are additionally based on glycidyl ethers of shorter-chain alcohols. Example 5 shows that the values from C3 and C4 can actually be bettered by a factor of 3 and 2 respectively. Here (ex. 5), it was possible to achieve extremely low interfacial tensions of 0.0023 mN/m.

1. A surfactant mixture comprising at least one surfactant of the general formula (I)
R¹O—(CH₂CH(CH₂OR²)O)ₚ-(D)ₙ-(B)ₘ-(A)ₗ-(X)ₖ—Y⁻1/bM^{b+} (I)
where
R¹ is a linear or branched, saturated or unsaturated aliphatic hydrocarbyl radical having 16 to 36 carbon atoms or an aliphatic-aromatic hydrocarbyl radical having 16 to 36 carbon atoms,
R² is a linear or branched, saturated or unsaturated aliphatic hydrocarbyl radical having 8 to 22 carbon atoms,
D is butyleneoxy,
B is propyleneoxy,
A is ethyleneoxy,
X is an alkylene, hydroxyalkylene or alkenylene group having 1 to 10 carbon atoms,
M^{b+} is a cation,
p is a number from 1 to 10,
n is a number from 0 to 99,
m is a number from 1 to 99,
l is a number from 1 to 99,
b is 1 or 2,
Y⁻ is SO₃⁻ and k is 0, or Y⁻ is a sulfonate (SO₃⁻)—, sulfate (OSO₃⁻)— or carboxylate group (CO₂⁻) and k is 1,
the alkyleneoxy groups (CH₂CH(CH₂OR²)O), A, B and D are distributed randomly, distributed alternately or are in the form of two, three, four, five or more blocks each of identical alkyleneoxy groups in any sequence,
and the sum of l+m+n+p is in the range from 3 to 99.

2. The surfactant mixture according to claim 1, where
m is a number from 4 to 15,
p is a number from 1 to 5,
the alkyleneoxy groups (CH₂CH(CH₂OR²)O), A, B and D are present to an extent of more than 60% in the form of two, three, four, five or more blocks each of identical alkyleneoxy groups in the sequence (CH₂CH(CH₂OR²)O), D, B, A, beginning from R¹O, and the sum of l+m+n+p is in the range from 5 to 70.

3. The surfactant mixture according to claim 1, where
n is a number from 2 to 15,
p is a number from 1 to 5,
the alkyleneoxy groups (CH2CH(CH2OR2)O), A, B and D are present to an extent of more than 60% in the form of two, three, four, five or more blocks each of identical alkyleneoxy groups in the sequence (CH₂CH(CH₂OR²)O), D, B, A, beginning from R¹O, and the sum of l+m+n+p is in the range from 5 to 70.

4. The surfactant mixture according to claim 1, where
R¹ is a linear or branched, saturated or unsaturated aliphatic hydrocarbyl radical having 16 to 22 carbon atoms or an aliphatic-aromatic hydrocarbyl radical having 16 to 22 carbon atoms,
R² is a linear or branched, saturated or unsaturated aliphatic hydrocarbyl radical having 8 to 22 carbon atoms, and
Y⁻ is a carboxylate group or a sulfate group and k in each case is 1.

5. The surfactant mixture according to claim 1, wherein an organic sulfonate having 14 to 28 carbon atoms is present as a further surfactant.

6. A process for producing mineral oil by means of Winsor type Ill microemulsion flooding, in which an aqueous surfactant formulation comprising at least one surfactant of the general formula (I), for the purpose of lowering the interfacial tension between oil and water to <0.1 mN/m, is injected through at least one injection well into a mineral oil deposit and crude oil is withdrawn through at least one production well from the deposit, wherein the aqueous surfactant formulation comprises at least one surfactant of the general formula (I) where, in
R¹O—(CH₂CH(CH₂OR²)O)ₚ-(D)ₙ-(B)ₘ-(A)ₗ-(X)ₖ—Y⁻1/bM^{b+} (I),
R¹ is a linear or branched, saturated or unsaturated aliphatic hydrocarbyl radical having 16 to 36 carbon atoms or an aliphatic-aromatic hydrocarbyl radical having 16 to 36 carbon atoms,
R² is a linear or branched, saturated or unsaturated aliphatic hydrocarbyl radical having 8 to 22 carbon atoms,
D is butyleneoxy,
B is propyleneoxy,
A is ethyleneoxy,
X is an alkylene, hydroxyalkylene or alkenylene having 1 to 10 carbon atoms, M^{b+} is a cation,
p is a number from 1 to 10,
n is a number from 0 to 99,
m is a number from 1 to 99,
l is a number from 1 to 99,
b is 1 or 2,
Y⁻ is SO₃⁻ and k is 0, or Y⁻ is a sulfonate (SO₃⁻)—, sulfate (OSO₃⁻)— or carboxylate group (CO₂⁻) and k is 1,
the alkyleneoxy groups (CH2CH(CH2OR2)O), A, B and D are distributed randomly, distributed alternately or are in the form of two, three, four, five or more blocks each of identical alkyleneoxy groups in any sequence,
and the sum of l+m+n+p is in the range from 3 to 99.

7. The process according to claim 6, where
m is a number from 4 to 15,
p is a number from 1 to 5,
the alkyleneoxy groups (CH₂CH(CH₂OR²)O), A, B and D are present to an extent of more than 60% in the form of two, three, four, five or more blocks each of identical alkyleneoxy groups in the sequence (CH₂CH(CH₂OR²)O), D, B, A, beginning from R¹O, and the sum of l+m+n+p is in the range from 5 to 70.

8. The process according to claim 6, where
n is a number from 2 to 15,
p is a number from 1 to 5,
the alkyleneoxy groups (CH₂CH(CH₂OR²)O), A, B and D are present to an extent of more than 60% in the form of two, three, four, five or more blocks each of identical alkyleneoxy groups in the sequence (CH₂CH(CH₂OR²)O), D, B, A, beginning from R¹O, and the sum of l+m+n+p is in the range from 5 to 70.

9. The process according to claim 6, where
R¹ is a linear or branched, saturated or unsaturated aliphatic hydrocarbyl radical having 16 to 22 carbon atoms or an aliphatic-aromatic hydrocarbyl radical having 16 to 22 carbon atoms,
R² is a linear or branched, saturated or unsaturated aliphatic hydrocarbyl radical having 8 to 22 carbon atoms, and
Y⁻ is a carboxylate group or a sulfate group and k in each case is 1.

10. The process according to claim 6, wherein an organic sulfonate having 14 to 28 carbon atoms is present as a further surfactant.

11. The process according to claim 6, where
R² is 2-ethylhexyl.

12. The process according to claim 6, where
R² is 2-propylheptyl.

13. The process according to claim 6, where
R² is n-dodecyl or n-tetradecyl or n-dodecyl and n-tetradecyl.

14. The process according to claim 6, where
R² is oleyl.

15. The process according to claim 6, wherein the concentration of all surfactants together is 0.05 to 5% by weight based on the total amount of the aqueous surfactant formulation.
